(19) United States
(12) Patent Application Publication
(10) Pub. No.: US 2003/0217067 A1
(43) Pub. Date: Nov. 20, 2003

(54) Method and system for conveying component data identifying a component and indicating component operating conditions

(75) Inventors: Raymond J. Gilstrap, Milpitas, CA (US); Lajos Moczar, Black Forest, CO (US)

Correspondence Address: Lawrence J. Merkel, Meyertons, Hood, Kivlin, Kowert & Goetzel, P.C., P.O. Box 398, Austin, TX, 78767, US

(73) Assignee: Sun Microsystems, Inc., Santa Clara, CA

(21) Appl. No.: 10/413,064

(22) Filed: Apr. 14, 2003

Related U.S. Application Data
(60) Provisional application No. 60/381,399, filed on May 17, 2002.
(60) Provisional application No. 60/381,116, filed on May 17, 2002.
(60) Provisional application No. 60/381,386, filed on May 17, 2002.
(60) Provisional application No. 60/381,131, filed on May 17, 2002.
(60) Provisional application No. 60/381,400, filed on May 17, 2002.
(60) Provisional application No. 60/381,130, filed on May 17, 2002.

(51) Int. Cl. G06F 7/00

(52) U.S. Cl. 707/100

(57) ABSTRACT

A method is disclosed for conveying component data identifying a component and indicating one or more states of the component existing during component operation (e.g., one or more component operating conditions). One embodiment of the method includes receiving a component data file including the component data, and transmitting the component data file (e.g., to a component data repository). Prior to the transmitting, the component data file may be compressed an/or encrypted. For example, a transmitted encrypted compressed component data file may be received and decrypted to produce a copy of a compressed component data file. The compressed component data file may be decompressed to produce a copy of the component data file, and the component data may be extracted from the component data file. Multiple component data files may be received at different times, compressed to produce corresponding compressed component data files, and the compressed component data files may be stored in a designated location. At a designated time, the compressed component data files may be retrieved, encrypted to produce corresponding encrypted compressed component data files, and the encrypted compressed component data files may be transmitted. A computer system implementing the method is described. A carrier medium is also described that includes program instructions for carrying out the method. The carrier medium may be, for example, a computer-readable storage medium such as a floppy disk or a compact disk read only memory (CD-ROM) disk.

This patent application claims benefit of priority to U.S. Provisional Patent Application Serial No. 60/381,399, filed on May 17, 2002. This patent application claims benefit of priority to U.S. Provisional Patent Application Serial No. 60/381,116, filed on May 17, 2002. This patent application claims benefit of priority to U.S. Provisional Patent Application Serial No. 60/381,386, filed on May 17, 2002. This patent application claims benefit of priority to U.S. Provisional Patent Application Serial No. 60/381,131, filed on May 17, 2002. This patent application claims benefit of priority to U.S. Provisional Patent Application Serial No. 60/381,400, filed on May 17, 2002. This patent application claims benefit of priority to U.S. Provisional Patent Application Serial No. 60/381,130, filed on May 17, 2002. The above applications are incorporated herein by reference in their entireties.

### BACKGROUND OF THE INVENTION

1. Field of the Invention

This invention relates generally to computer systems and, more particularly, to systems and methods for gathering and conveying data regarding component operating conditions.

2. Description of the Related Art

The demand for network computing hardware and software has increased significantly over the past few years, due in large part to the emergence of the Internet. Notable trends in network computing include a boom in the growth of application service providers (ASPs), companies that offer access to applications and/or services via the Internet that would otherwise require costly computer hardware and/or software at a customer's site. Services currently offered by ASPs include remote access serving for mobile users, access to specialized applications, distribution of product data to potential customers via the Internet, and secure Internet sales order processing.

A “high-end” server system is an example of a processor-based system used in a network-centric environment. High-end servers are typically employed in computer networks requiring high communication speeds (i.e., high communication bandwidths), and high availabilities. As system downtime often equates to lost revenue, minimizing system downtime is an important system management goal. As a result, high-end server systems typically include replaceable components or modules that can be removed and installed without shutting down the system. This on-line component replacement capability is commonly referred to as “hot-pluggable” or “hot-swappable” capability.

Current desktop computer systems typically include “disposable” components. That is, when a component of a desktop computer system fails, the failed component is typically replaced with a new component, and the failed component is typically discarded without repair. In contrast, components of high-end server systems are typically repairable. When a component of a high-end server fails, the failed component is typically replaced with a new or repaired component, and the failed component is typically returned to the manufacturer, or sent to a third-party vendor associated with the manufacturer, for repair. Following repair, the repaired component may be shipped to another customer and installed in the other customer's high-end server.

Such repairable components are commonly referred to as “field replaceable units” (FRUs). During the service life of a FRU, the FRU may be installed in server systems of several different customers. Examples of server system FRUs include system control boards (i.e., motherboards), central processing unit (CPU) boards, memory modules, input/output (I/O) boards, power supplies, and cooling fans.

To further improve the reliabilities and availabilities of high-end server systems, it is useful to establish relationships between FRU failures and FRU operating condition histories so that FRU failures may be predicted, and FRUs subject to failure may be replaced before the failures occur. Such information may also be used to determine underlying causes of FRU failures so that the underlying causes may be eliminated in newly manufactured and/or repaired FRUs. To establish relationships between FRU failures and FRU operating condition histories, data regarding FRU operating conditions is gathered over time, stored, and processed to produce FRU operating condition histories. The resulting FRU operating condition histories may then be analyzed in conjunction with FRU failures to determine the relationships.

It would thus be beneficial to have systems and methods for gathering data regarding FRU operating conditions over time, storing the data, and processing the data to produce FRU operating condition histories. It would also be beneficial to have systems and methods for analyzing FRU operating condition histories in conjunction with FRU failures. Such systems and methods would facilitate efforts to improve the reliabilities and availabilities of high-end server systems.

### SUMMARY OF THE INVENTION

A method is disclosed for conveying component data, wherein the component data identifies a component and indicates one or more states of the component existing during component operation (e.g., one or more component operating conditions). One embodiment of the method includes receiving a component data file including the component data, and transmitting the component data file (e.g., to a component data repository). Prior to the transmitting, the component data file may be compressed and/or encrypted. Compressing the component data file may result in a compressed component data file, wherein a size of the compressed component data file is less than that of the component data file.

For example, the method may be embodied within a local file server at a local site, and the local file server may transmit the component data file to a remote file server at a remote site. In one embodiment, prior to transmission, the local file server compresses the component data file to produce a compressed component data file, then encrypts the compressed component data file to produce an encrypted compressed component data file. The remote file server receives the encrypted compressed component data file transmitted by the local file server, and decrypts the encrypted compressed component data file to produce a copy of the compressed component data file. The remote file server decompresses the compressed component data file to produce a copy of the component data file, and extracts the component data from the component data file. The remote file server may provide the component data to a storage system server for storage in a component data database, thus creating an operating condition history for the component.

A first portion of the component data may include data that identifies the component and/or manufacturing data associated with the component. A second portion of the component data may include data acquired during operation of the component and associated with an operational state of the component.

In a second embodiment of the method, multiple component data files are received at different times, and prior to a designated time. Each of the component data files corresponds to a different one of multiple components. Each of the component data files is received, compressed to produce a corresponding compressed component data file, and the corresponding compressed component data file is stored in a designated location. At the designated time, each of the compressed component data files stored in the designated location is retrieved from the designated location, encrypted to produce a corresponding encrypted compressed component data file, and the corresponding encrypted compressed component data file is transmitted.

A computer system is described that implements the method. A carrier medium is also described that includes program instructions for carrying out the method. The carrier medium may be, for example, a computer-readable storage medium such as a floppy disk or a compact disk read only memory (CD-ROM) disk.

### BRIEF DESCRIPTION OF THE DRAWINGS

The invention may be understood by reference to the following description taken in conjunction with the accompanying drawings, in which like reference numerals identify similar elements, and in which:

FIG. 1 is a diagram of one embodiment of a computer system including multiple computer systems coupled to a local file server at a “local” site, and a remote file server, a FRU image repository (FIR) server, and a FIR database at site remote from the local site (i.e., a “remote” site), wherein field replaceable unit (FRU) identification (ID) data is transferred from the local site to the remote site;

FIG. 2 is a diagram of one embodiment of a representative one of the computer systems at the local site of FIG. 1, wherein the representative computer system includes multiple field replaceable units (FRUs), and wherein each of the FRUs includes a non-volatile memory;

FIG. 3 is a diagram of one embodiment of a non-volatile memory of a representative one of the multiple field replaceable units (FRUs) of FIG. 2, wherein the non-volatile memory includes field replaceable unit (FRU) identification (ID) data corresponding to the FRU containing the non-volatile memory, and wherein the FRU ID data includes a static portion and a dynamic portion;

FIG. 4 is a diagram of one embodiment of the local file server of FIG. 1, wherein the local file server includes a central processing unit (CPU) coupled to a memory, and wherein FRU ID data repository (FIR) upload software resides in the memory;

FIG. 5 is a flow chart of one embodiment of a method for conveying the field replaceable unit (FRU) identification (ID) data of FIG. 3 from a given one of the computer systems of FIG. 1 to the local file server of FIGS. 1 and 4;

FIG. 6 is a flow chart of one embodiment of a method for conveying the field replaceable unit (FRU) identification (ID) data of FIG. 3 to the remote file server of FIG. 1, wherein the method may be embodied within the FRU image repository (FIR) upload software of FIG. 4;

FIG. 7 is a flow chart of one embodiment of a method for conveying the field replaceable unit (FRU) identification (ID) data of FIG. 3 to the FRU image repository (FIR) server of FIG. 1, wherein the method may be embodied within the remote file server of FIG. 1; and

FIG. 8 is a flow chart of one embodiment of a method for storing the field replaceable unit (FRU) identification (ID) data of FIG. 3 in the FRU image repository (FIR) database of FIG. 1, wherein the method may be embodied within the FRU image repository (FIR) server of FIG. 1.

While the invention is susceptible to various modifications and alternative forms, specific embodiments thereof have been shown by way of example in the drawings and are herein described in detail. It should be understood, however, that the description herein of specific embodiments is not intended to limit the invention to the particular forms disclosed, but on the contrary, the intention is to cover all modifications, equivalents, and alternatives falling within the spirit and scope of the invention as defined by the appended claims.

### DETAILED DESCRIPTION OF SPECIFIC EMBODIMENTS

Illustrative embodiments of the invention are described below. In the interest of clarity, not all features of an actual implementation are described in this specification. It will, of course, be appreciated that in the development of any such actual embodiment, numerous implementation-specific decisions must be made to achieve the developers' specific goals, such as compliance with system-related and business-related constraints, which will vary from one implementation to another. Moreover, it will be appreciated that such a development effort might be complex and time-consuming, but would nevertheless be a routine undertaking for those of ordinary skill in the art having the benefit of this disclosure.

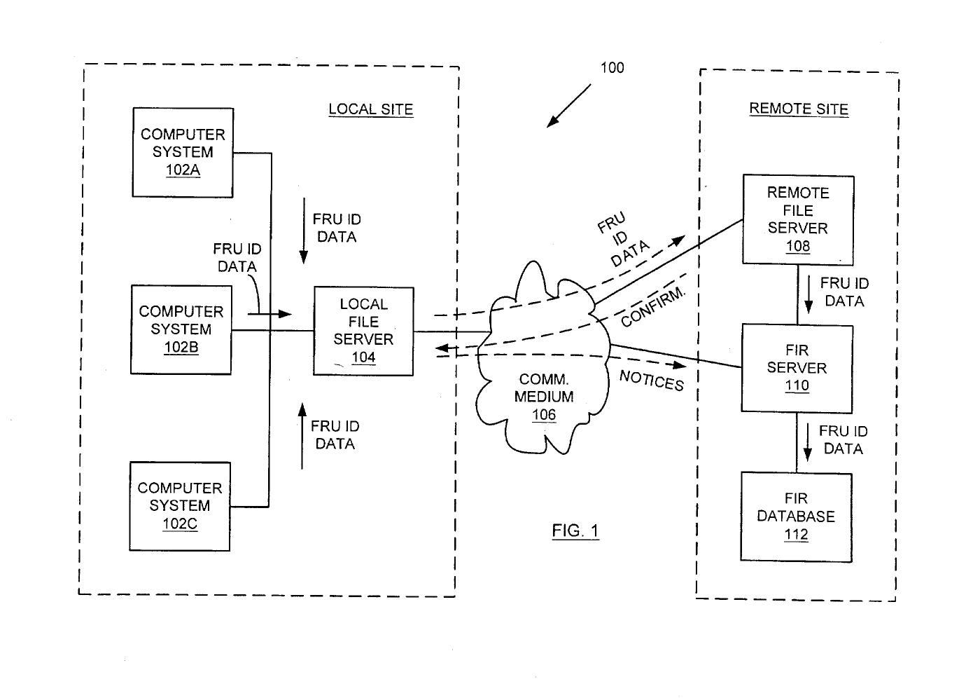

FIG. 1 is a diagram of one embodiment of a computer system 100, wherein field replaceable unit (FRU) identification (ID) data is transferred from a “local” site to a FRU image repository (FIR) located at a site remote from the local site (i.e., a “remote” site). In the embodiment of FIG. 1, multiple computer systems 102A-C (e.g., workstations) are coupled to a “local” file server 104 at the local site. The local file server 104 is coupled to, and communicates with, a “remote” file server 108, located at the remote site, via a communication medium 106 (e.g., a circuit-switched medium such as a telephone system, a packet-switched medium such as the Internet, etc.). At the remote site, a FRU image repository (FIR) server 110 is coupled between the remote file server 108 and a FRU image repository (FIR) database 112. As indicated in FIG. 1, the FIR server 110 is also coupled to, and communicates with, the local file server 104 at the local site.

As indicated in FIG. 1, and described in detail below, the computer systems 102A-C provide field replaceable unit (FRU) identification (ID) data, regarding field replaceable units within the computer systems 102A-C, to the local file server 104. In one embodiment, the local file server 104 receives separate files including FRU ID data from the computer systems 102A-C. In one embodiment, the local file server 104 compresses the files containing the FRU ID data. Periodically (e.g., once a day), the local file server 104 encrypts the compressed FRU ID data files, and transmits compressed and encrypted FRU ID data files to the remote file server 108 via the communication medium 106. For example, the communication medium 106 may be the Internet, and the local file server 104 may use the well known file transfer protocol (FTP), commonly used to transfer documents via the Internet, to transmit the compressed and encrypted FRU ID data files to the remote file server 108.

Following transmission of the compressed and encrypted FRU ID data files to the remote file server 108, the local file server 104 transmits a FRU ID data transmission notice to the FRU image repository (FIR) server 110 via the communication medium 106. In response to the FRU ID data transmission notice, the FIR server 110 readies the FIR database 112 for the corresponding FRU ID data.

After receiving the compressed and encrypted files containing the FRU ID data, the remote file server 108 attempts to decompress and decrypt the data files. The remote file server 108 also generates confirmation of the received field replaceable unit (FRU) identification (ID) data. In one embodiment, the confirmation comprises a text file including the names of the one or more received compressed and encrypted files containing the FRU ID data, and a success flag for each of the one or more compressed and encrypted FRU ID data files indicating whether the attempt to decompress and decrypt the corresponding file was successful. The local file server 104 may retrieve the text file from the remote server 108. Alternately, the remote server 108 may send the text file to the local file server 104.

After successful decompression and decryption of a compressed and encrypted file containing field replaceable unit (FRU) identification (ID) data, the remote file server 108 provides the FRU ID data to the FIR server 110. The FIR server 110 stores the FRU ID data in the FRU image repository (FIR) database 112.

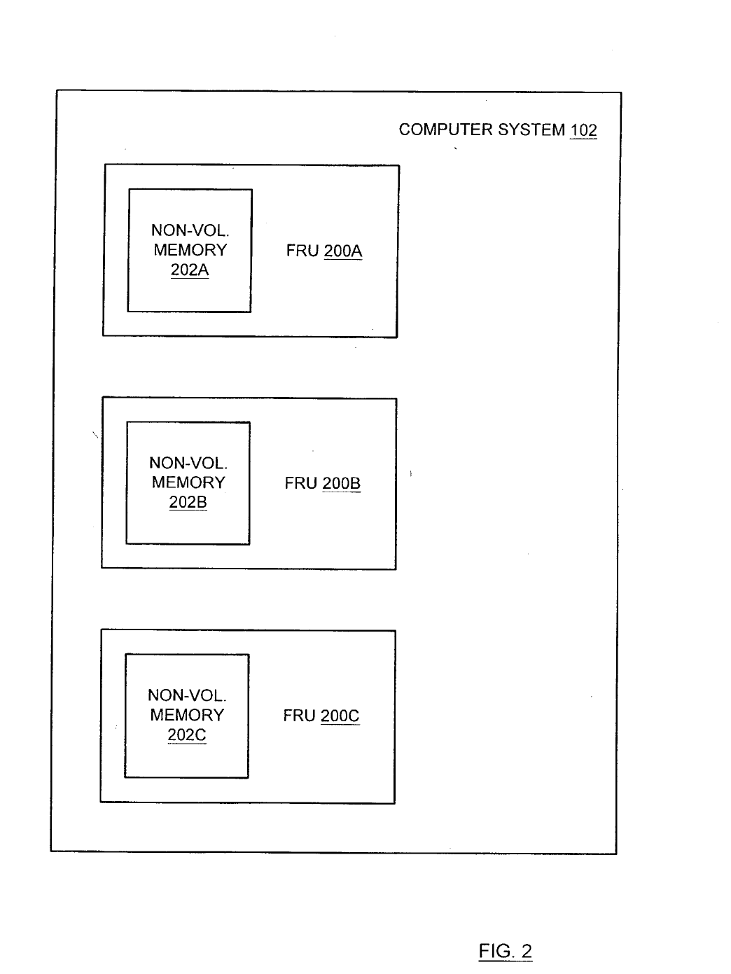

FIG. 2 is a diagram of one embodiment of a representative one of the computer systems 102 of FIG. 1. In the embodiment of FIG. 2, the representative computer system 102 includes multiple field replaceable units (FRUs) 200A, 200B, and 200C. The FRUs 200 may include, for example, a motherboard, a central processing unit (CPU), a memory module (e.g., a SIMM, a DIMM, etc.), and various peripheral/controller cards (e.g., CD-ROM, SCSI, audio, etc.). Each of the FRUs 200 includes a non-volatile memory. In FIG. 2, the FRU 200A includes a non-volatile memory 202A, the FRU 200B includes a non-volatile memory 202B, and FRU 200C includes a non-volatile memory 202C. The non-volatile memories 202A-C may include, for example, electrically erasable programmable read only memory (EEPROM), flash memory, etc. In one embodiment, the non-volatile memories 202A-C include serial electrically erasable programmable read only memory (SEEPROM).

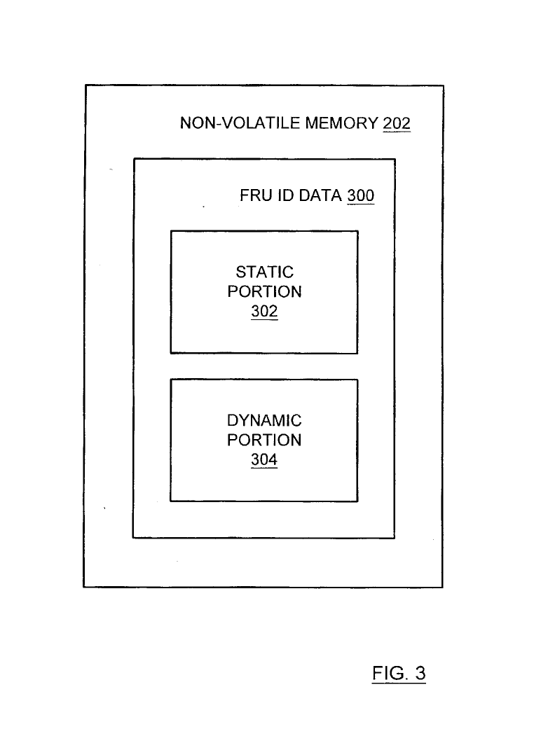

FIG. 3 is a diagram of one embodiment of a non-volatile memory 202 of a representative one of the multiple field replaceable units (FRUs) of FIG. 2. In the embodiment of FIG. 3, the non-volatile memory 202 includes field replaceable unit (FRU) identification (ID) data 300 corresponding to the FRU 200 (FIG. 2). The FRU ID data 300 includes a static portion 302 and a dynamic portion 304. The static portion 302 is used to store FRU ID data not expected to change over the operational life of the FRU 200. Such data may include data that identifies the FRU 200, and/or manufacturing data regarding the FRU 200. The data stored in the static portion 302 may include, for example, a part number of the FRU 200, a serial number of the FRU 200, a name of a manufacturer of the FRU 200, an Ethernet address of the FRU 200, a maximum speed/power of the FRU 200, etc. After manufacturing of the FRU 200 and writing of data into the static portion 302, the static portion 302 may be made read only.

The dynamic portion 304 is used to store FRU ID data expected to change during the operational life of the FRU 200. Such data may include data indicative of a state of the FRU 200 existing during operation of the FRU 200. The data stored in the dynamic portion 304 may include, for example, a total number of hours the FRU 200 has received electrical power, system hardware level information of the FRU 200, test information and test results of the FRU 200, an error log of the FRU 200, a temperature log of the FRU 200, a repair history of the FRU 200, geographic location information of the FRU 200, a total number of power on/off cycles of the FRU 200, etc. The dynamic portion 304 may be written to (i.e., updated) by the FRU 200, and/or the computer system 102 (FIGS. 1-2) including the FRU 200.

In contemplated embodiments, the FRU ID data 300 of FIG. 3 includes binary data. In this situation, the binary data of the FRU ID data 300 of FIG. 3 constitutes a “FRU image.” As used herein, the term “FRU image” refers to a binary image (i.e., a bit-for-bit copy) of the FRU ID data 300 stored within the non-volatile memory 202 (FIG. 3) of a particular FRU 200 (FIG. 2), and a “FRU image file” is a computer file containing a FRU image.

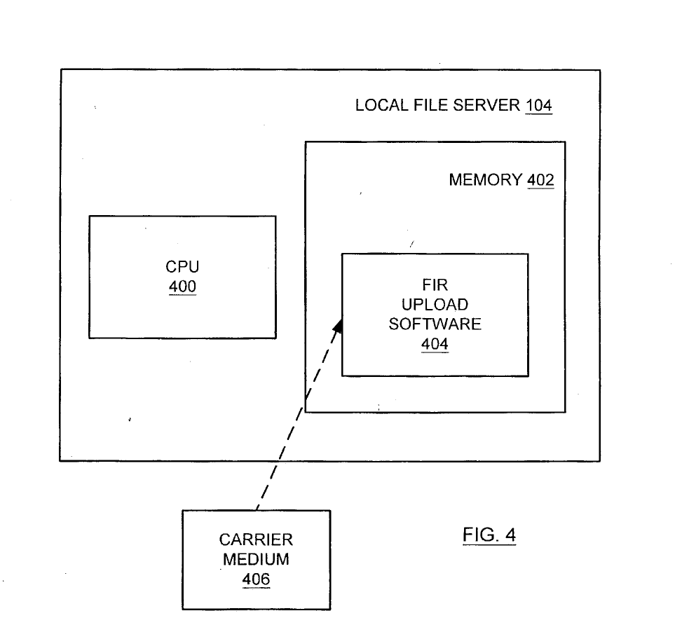

FIG. 4 is a diagram of one, embodiment of the local file server 104 of FIG. 1. In FIG. 4, the local file server 104 includes a central processing unit (CPU) 400 coupled to a memory 402. FRU ID data repository (FIR) upload software 404 resides in the memory 402. During operation of the local file server 104, the CPU 400 executes instructions of the FIR upload software 404. In general, the instructions of the FIR upload software 404 cause the CPU 400 to compress the FRU ID data files received from the computer systems 102 (FIG. 1) and containing the FRU ID data, to encrypt the compressed FRU ID data files, and to transmit the compressed and encrypted FRU ID data files to the remote file server 108 (FIG. 1) via the communication medium 106 (FIG. 1).

In FIG. 4, a carrier medium 406 is used to convey the FIR upload software 404 to the memory 402. For example, the local file server 104 may include a disk drive for receiving removable disks (e.g., a floppy disk drive, a compact disk read only memory or CD-ROM drive, etc.), and the carrier medium 406 may be a disk (e.g., a floppy disk, a CD-ROM disk, etc.) embodying the FIR upload software 404. The CPU 400 may read the code of the FIR upload software 404 from the carrier medium 406, and store the code in the memory 402.

Alternately, the carrier medium 406 may be a signal (e.g., a carrier signal) used to convey the code of the FIR upload software 404 to the local file server 104. For example, the local file server 104 may include a network interface card coupled to the communication medium 106 (FIG. 1), and the carrier medium 406 may be a signal (e.g., an electrical signal or an optical signal) conveyed via the communication medium 106 to the network interface card. The local file server 104 may receive the code of the FIR upload software 404 via the carrier medium 406, and store the code in the memory 402.

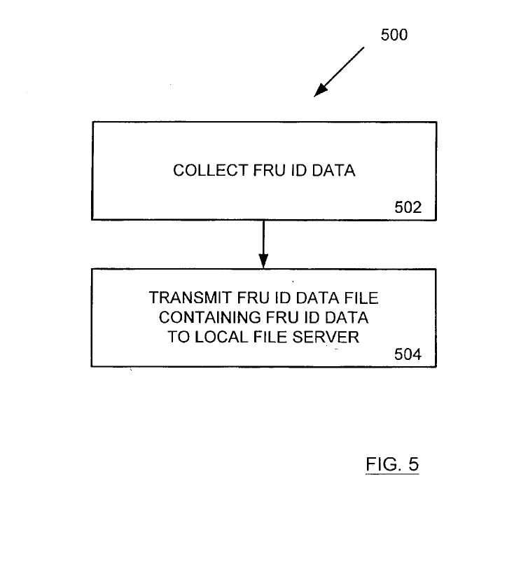

FIG. 5 is a flow chart of one embodiment of a method 500 for conveying the field replaceable unit (FRU) identification (ID) data 300 (FIG. 3) from a given one of the computer systems 102 (FIG. 1) to the local file server 104 (FIGS. 1 and 4). The method 500 may be embodied within each of the computer systems 102 (FIG. 1). During a step 502 of the method 500, the given one of the computer systems 102 collects FRU ID data from each of the FRUs 200 (FIG. 2) within the given computer system 102. The given computer system 102 then generates a FRU ID data file (e.g., a FRU image file) including the FRU ID data 300, and transmits the FRU ID data file to the local file server 104 during a step 504. The given computer system 102 may perform the method 500 periodically and/or in response to a signal from the local file server 104. The local file server 104 may signal the given computer system 102 to perform the method 500 in response to a signal received from the remote file server 108 (FIG. 1) via the communication medium 106 (FIG. 1).

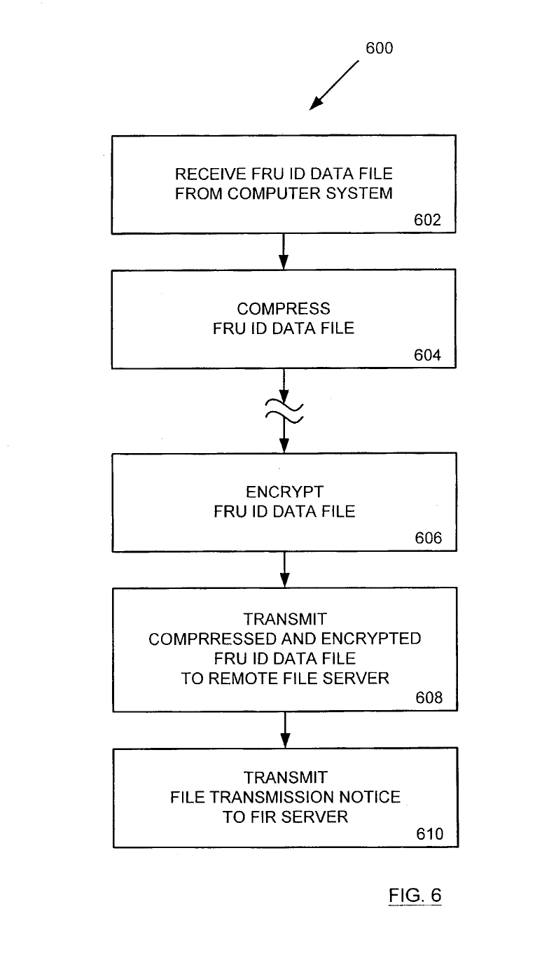

FIG. 6 is a flow chart of one embodiment of a method 600 for conveying the field replaceable unit (FRU) identification (ID) data 300 (FIG. 3) to the remote file server 108 (FIG. 1). The method 600 may be embodied within the FRU image repository (FIR) upload software 404 (FIG. 4). During a step 602 of the method 600, the local file server 104 receives a FRU ID data file (e.g., a FRU image file), containing FRU ID data, from one of the computer systems 102 (FIG. 1). The local file server 104 compresses the FRU ID data file during a step 604. For example, the local file server 104 may use commercially available “zip” compression software to compress the FRU ID data file to form a “zip” file during the step 604.

During a step 606, the local file server 104 encrypts the compressed FRU ID data file (e.g., using the well known triple data encryption standard, or 3DES, algorithm). The local file server 104 transmits the compressed and encrypted FRU ID data file to the remote file server 108 during a step 608 (e.g., via the communication medium 106 of FIG. 1). As described above, the communication medium 106 may be the Internet, and the local file server 104 may use the well known file transfer protocol (FTP), commonly used to transfer documents via the Internet, to transmit the compressed and encrypted FRU ID data files to the remote file server 108. It is noted that other encryption and transport protocols may be employed.

As described above, the local file server 104 may transmit FRU ID data files to the remote file server 108 periodically (e.g., once a day). In this situation, the local file server 104 may store one or more received compressed FRU ID data files (e.g., in a temporary directory stored in the memory 402) for later encryption and transmission to the remote file server 108.

During a step 610, the local file server 104 transmits a FRU ID data transmission notice to the FRU image repository (FIR) server 110 (e.g., via the communication medium 106). As described above, in response to the FRU ID data transmission notice, the FIR server 110 may ready the FIR database 112 for the corresponding FRU ID data.

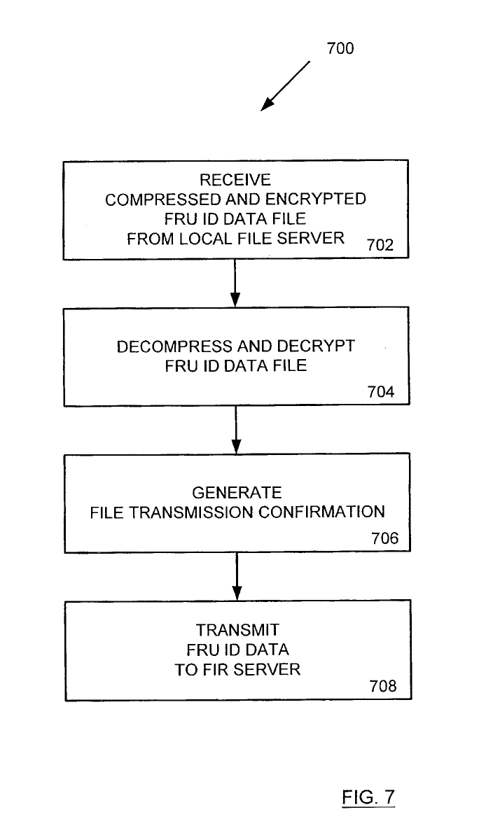

FIG. 7 is a flow chart of one embodiment of a method 700 for conveying the field replaceable unit (FRU) identification (ID) data 300 (FIG. 3) to the FRU image repository (FIR) server 110 (FIG. 1). The method 700 may be embodied within the remote file server 108 of FIG. 1. During a step 702 of the method 700, the remote file server 108 receives a compressed and encrypted FRU ID data file (e.g., a compressed and encrypted FRU image file) from the local file server 104 (FIGS. 1 and 4). During a step 704, the remote file server 108 attempts to decompress and decrypt the received FRU ID data file. The remote file server 108 generates a confirmation of the received FRU ID data during a step 706. As described above, the confirmation may comprise a text file including the names of one or more received compressed and encrypted files containing the FRU ID data, and a success flag for each of the one or more compressed and encrypted FRU ID data files indicating whether the attempt to decompress and decryption the corresponding file during the step 704 was successful. The local file server 104 may retrieve the text file from the remote server 108. Alternately, the remote server 108 may send the text file to the local file server 104. During a step 708, the remote file server 108 transmits the FRU ID data to the FIR server 110 (FIG. 1).

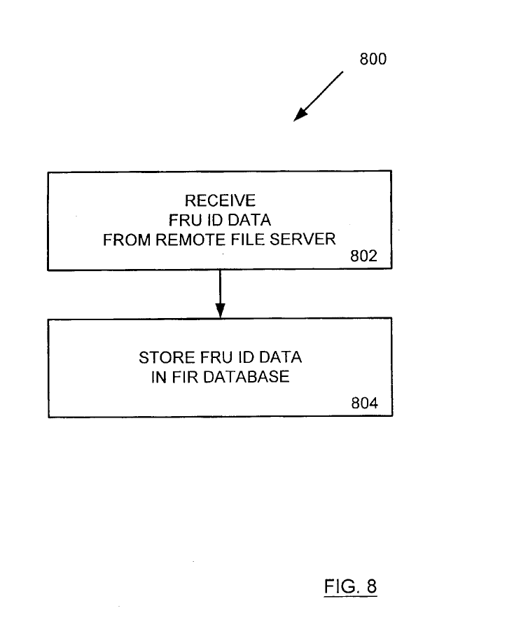

FIG. 8 is a flow chart of one embodiment of a method 800 for storing the field replaceable unit (FRU) identification (ID) data 300 (FIG. 3) in the FRU image repository (FIR) database 112 (FIG. 1). The method 800 may be embodied within the FRU image repository (FIR) server 10 of FIG. 1. During a step 802 of the method 800, the FIR server 110 receives the FRU ID data from the remote file server 108 (FIG. 1). The FIR server 110 stores the received FRU ID data in the FRU image repository (FIR) database 112 during a step 804.

Referring to FIGS. 5-8 collectively, the remote file server 108 (FIG. 1) may, for example, transmit a first signal (e.g., a periodic component data request) to the local file server 104 via the communication medium 106. The first signal may identify a particular field replaceable unit (FRU) 200 (FIG. 2) of a given one of the computer systems 102 (FIGS. 1-2). In response to the first signal, the local file server 104 send a second signal to the given computer system 102 (FIG. 1). In response to the second signal, the given computer system 102 may perform the method 500 of FIG. 5, thereby collecting FRU ID data associated with the particular FRU 200, and transmitting a FRU ID data file including the FRU ID data to the local file server 104. The local file server 104 may then perform the method 600 of FIG. 6, thereby transmitting the FRU ID data file to the remote file server 108. The remote file server 108 may then perform the method 700 of FIG. 7, thereby transmitting the FRU ID data to the FIR server 110 (FIG. 1). The FIR server 110 may perform the method 800 of FIG. 8, thereby storing the FRU ID data in the FIR database 112 (FIG. 1).

The particular embodiments disclosed above are illustrative only, as the invention may be modified and practiced in different but equivalent manners apparent to those skilled in the art having the benefit of the teachings herein. Furthermore, no limitations are intended to the details of construction or design herein shown, other than as described in the claims below. It is therefore evident that the particular embodiments disclosed above may be altered or modified and all such variations are considered within the scope and spirit of the invention. Accordingly, the protection sought herein is as set forth in the claims below.

What is claimed is:

1. A method for conveying component data, comprising:
receiving a component data file comprising the component data, wherein the component data identifies the component and is indicative of a state of the component existing during operation of the component; and
transmitting the component data file to a repository.

2. The method as recited in claim 1, wherein the receiving comprises:
receiving a component data file comprising the component data, wherein a first portion of the component data comprises data that identifies the component, and wherein a second portion of the component data comprises data acquired during operation of the component and associated with an operational state of the component.

3. The method as recited in claim 1, wherein the receiving comprises:
receiving a component data file comprising the component data, wherein a first portion of the component data comprises data that identifies the component and is indicative of manufacturing data associated with the component, and wherein a second portion of the component data comprises data acquired during operation of the component and associated with an operational state of the component.

4. The method as recited in claim 1, wherein the receiving comprises:
receiving a component data file comprising the component data, wherein a first portion of the component data comprises data that identifies the component, and wherein a second portion of the component data comprises data acquired by the component during operation of the component and associated with an operational state of the component.

5. The method as recited in claim 1, further comprising:
receiving the component data file; and
extracting the component data from the component data file.

6. A method for conveying component data, comprising:
receiving a component data file comprising the component data, wherein the component data identifies the component and is indicative of a state of the component existing during operation of the component;
compressing the component data file to produce a compressed component data file, wherein a size of the compressed component data file is less than that of the component data file;
encrypting the compressed component data file to produce an encrypted compressed component data file; and
transmitting the encrypted compressed component data file.

7. The method as recited in claim 6, wherein the receiving comprises:
receiving a component data file comprising the component data, wherein a first portion of the component data comprises data that identifies the component, and wherein a second portion of the component data comprises data acquired during operation of the component and associated with an operational state of the component.

8. The method as recited in claim 6, wherein the receiving comprises:
receiving a component data file comprising the component data, wherein a first portion of the component data comprises data that identifies the component and is indicative of manufacturing data associated with the component, and wherein a second portion of the component data comprises data acquired during operation of the component and associated with an operational state of the component.

9. The method as recited in claim 6, wherein the receiving comprises:
receiving a component data file comprising the component data, wherein a first portion of the component data comprises data that identifies the component, and wherein a second portion of the component data comprises data acquired by the component during operation of the component and associated with an operational state of the component.

10. The method as recited in claim 6, further comprising:
receiving the encrypted compressed component data file;
decrypting the encrypted compressed component data file to produce a copy of the compressed component data file;
decompressing the compressed component data file to produce a copy of the component data file; and
extracting the component data from the component data file.

11. A method for conveying component data, comprising:
performing the following for each of a plurality of component data files received at different times and prior to a designated time, wherein each of the component data files corresponds to a different one of a plurality of components:
receiving the component data file, wherein the component data file comprises component data that identifies the corresponding component and is indicative of a state of the corresponding component existing during operation of the corresponding component;
compressing the component data file to produce a corresponding compressed component data file, wherein a size of the compressed component data file is less than that of the component data file; and
storing the compressed component data file in a designated location;
at the designated time, performing the following for each of the compressed component data files stored in the designated location:
retrieving the compressed component data file from the designated location;
encrypting the compressed component data file to produce a corresponding encrypted compressed component data file; and
transmitting the encrypted compressed component data file.

12. The method as recited in claim 11, further comprising:
performing the following for each of the encrypted compressed component data files:
receiving the encrypted compressed component data file;
decrypting the encrypted compressed component data file to produce a copy of the corresponding compressed component data file;
decompressing the compressed component data file to produce a copy of the corresponding component data file; and
extracting the component data from the component data file.

13. A computer system, comprising:
a memory storing program instructions; and
a central processing unit (CPU) configured to access the program instructions in the memory and to execute the program instructions;
wherein when the CPU executes the program instructions, the computer system is configured to receive a component data file comprising component data and to transmit the component data file, wherein the component data identifies a component and is indicative of a state of the component existing during operation of the component.

14. A carrier medium comprising program instructions for conveying component data, wherein the program instructions are operable to implement:
receiving a component data file comprising the component data, wherein the component data identifies the component and is indicative of a state of the component existing during operation of the component; and
transmitting the encrypted compressed component data file.

15. The carrier medium as recited in claim 14, wherein the carrier medium is a computer-readable storage medium.

16. The carrier medium as recited in claim 15, wherein the computer-readable storage medium is a floppy disk or a compact disk read only memory (CD-ROM) disk.

17. A computer system, comprising:
a memory storing program instructions; and
a central processing unit (CPU) configured to access the program instructions in the memory and to execute the program instructions;
wherein when the CPU executes the program instructions, the computer system is configured to: (i) receive a component data file comprising component data, wherein the component data identifies a component and is indicative of a state of the component existing during operation of the component, (ii) compress the component data file to produce a compressed component data file, wherein a size of the compressed component data file is less than that of the component data file, (iii) encrypt the compressed component data file to produce an encrypted compressed component data file, and (iv) transmit the encrypted compressed component data file.

18. A carrier medium comprising program instructions for conveying component data, wherein the program instructions are operable to implement:
receiving a component data file comprising the component data, wherein the component data identifies the component and is indicative of a state of the component existing during operation of the component;
compressing the component data file to produce a compressed component data file, wherein a size of the compressed component data file is less than that of the component data file;
encrypting the compressed component data file to produce an encrypted compressed component data file; and
transmitting the encrypted compressed component data file.

19. The carrier medium as recited in claim 18, wherein the carrier medium is a computer-readable storage medium.

20. The carrier medium as recited in claim 19, wherein the computer-readable storage medium is a floppy disk or a compact disk read only memory (CD-ROM) disk.

21. A carrier medium comprising program instructions for conveying component data, wherein the program instructions are operable to implement:
performing the following for each of a plurality of component data files received at different times and prior to a designated time, wherein each of the component data files corresponds to a different one of a plurality of components:
receiving the component data file, wherein the component data file comprises component data that identifies the corresponding component and is indicative of a state of the corresponding component existing during operation of the corresponding component;
compressing the component data file to produce a corresponding compressed component data file, wherein a size of the compressed component data file is less than that of the component data file; and
storing the compressed component data file in a designated location;
at the designated time, performing the following for each of the compressed component data files stored in the designated location:
retrieving the compressed component data file from the designated location;
encrypting the compressed component data file to produce a corresponding encrypted compressed component data file; and
transmitting the encrypted compressed component data file.

22. The carrier medium as recited in claim 21, wherein the carrier medium is a computer-readable storage medium.

23. The carrier medium as recited in claim 22, wherein the computer-readable storage medium is a floppy disk or a compact disk read only memory (CD-ROM) disk.

24. A method for conveying component data, comprising:
providing a field replaceable unit having a memory device configured to store component data, wherein the component data identifies the field replaceable unit and is indicative of a state of the field replaceable unit existing during operation of the field replaceable unit;
accessing the field replaceable unit to retrieve the component data;
generating a component data file dependent upon the component data; and
transmitting the component data file.

25. A computer system, comprising:
a field replaceable unit including a memory device configured to store component data, wherein the component data identifies the field replaceable unit and is indicative of a state of the field replaceable unit existing during operation of the field replaceable unit; and
a processing unit operably coupled to the field replaceable unit and to a communication medium, wherein the processing unit is configured to access the memory device, to retrieve the component data from the memory device, to generate a component data file dependent upon the component data, and to transmit the component data file via the communication medium.

26. A system, comprising:
a first computer system coupled to a communication medium and comprising a field replaceable unit, the field replaceable unit having a memory device configured to store component data associated with the field replaceable unit, the first computer system being adapted to access the memory device to retrieve the component data, to generate a component data file dependent upon the component data, and to transmit the component data file via the communication medium; and
a second computer system coupled to the communication medium and configured to receive the component data file via the communication medium, and to extract the component data from the component data file.

27. The system as recited in claim 26, wherein the component data identifies the field replaceable unit and is indicative of a state of the field replaceable unit existing during operation of the field replaceable unit.

28. The system as recited in claim 26, wherein the first computer system is configured to generate and transmit the component data file periodically.

29. The system as recited in claim 26, wherein the second computer system is configured to transmit a component data request to the first computer system via the communication medium, and wherein the first computer system is configured to generate the component data file and to transmit the component data file to the second computer system in response to the component data request.

30. The system as recited in claim 26, wherein the second computer system comprises a component data repository, and wherein the second computer system is configured to store the component data in the component data repository.

31. A method for conveying component data to a remote location, comprising:
receiving a component data file comprising the component data at the remote location, wherein the component data identifies the component and is indicative of a state of the component existing during operation of the component;
extracting the component data from the component data file; and
storing the component data in a repository at the remote location.

32. The method as recited in claim 31, wherein the receiving comprises:
receiving a component data file comprising the component data at the remote location, wherein a first portion of the component data comprises data that identifies the component, and wherein a second portion of the component data comprises data acquired during operation of the component and associated with an operational state of the component.

33. The method as recited in claim 31, wherein the receiving comprises:
receiving a component data file comprising the component data at the remote location, wherein a first portion of the component data comprises data that identifies the component and is indicative of manufacturing data associated with the component, and wherein a second portion of the component data comprises data acquired during operation of the component and associated with an operational state of the component.

34. The method as recited in claim 31, wherein the receiving comprises:
receiving a component data file comprising the component data at the remote location, wherein a first portion of the component data comprises data that identifies the component, and wherein a second portion of the component data comprises data acquired by the component during operation of the component and associated with an operational state of the component.
